(19) United States
(12) Patent Application Publication
(10) Pub. No.: US 2010/0262840 A1
(43) Pub. Date: Oct. 14, 2010

(54) METHOD AND DEVICES FOR PROTECTING A MICROCIRCUIT FROM ATTACKS FOR OBTAINING SECRET DATA

(75) Inventors: Bruno BENTEO, Toulouse (FR); Benoit FEIX, La Ciotat (FR); Sébastien NEROT, Jouques (FR)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: INSIDE CONTACTLESS, Aix enProvence Cedex 03 (FR)

(21) Appl. No.: 12/768,837

(22) Filed: Apr. 28, 2010

Related U.S. Application Data
(63) Continuation of application No. PCT/FR2008/001544, filed on Nov. 3, 2008.

(30) Foreign Application Priority Data
Nov. 2, 2007 (FR) 07 07695

(51) Int. Cl. G06F 21/22; H04L 9/28

(52) U.S. Cl. 713/190; 380/28

(57) ABSTRACT

A method of protecting a microcircuit against attacks aimed at discovering secret data used on the execution, by the microcircuit, of an encryption algorithm includes generating at least one protection parameter for the secret data and modifying the execution of the encryption algorithm through that protection parameter. Generation of the at least one protection parameter includes defining a function generating, by successively applying to at least one secret parameter which is stored in memory, a sequence of values which can only be determined from that secret parameter and that function, and to generate the protection parameter in a reproducible way from at least one value in that sequence.

### CROSS-REFERENCE TO RELATED APPLICATIONS

This application is a Continuation of International Application No. PCT/FR2008/001544, filed Nov. 3, 2008, which was published in the French language on Jul. 30, 2009, under International Publication No. WO 2009/092903 A2 and the disclosure of which is incorporated herein by reference.

### BACKGROUND OF THE INVENTION

Embodiments of the present invention relate to a method and systems for protecting microcircuits against attacks intended to discover secret data used during the execution by the microcircuit of an encryption algorithm.

As illustrated in FIG. 1, an encryption algorithm application 10 is generally implemented by a microcircuit 12 to secure the transmission or reception of a message M. Among the secret data it is likely to use during its execution, there is a key K, referred to as “secret” in symmetric cryptography and “private” in asymmetric cryptography. There may also be the message M itself. The secret or private key K is, for example, stored in the microcircuit 12, which has a memory 14 itself including a secure memory space 16 intended for that purpose and a microprocessor 18 to execute the encryption algorithm 10. The message M may also be intended to be stored, at least temporarily, in the secure memory space 16.

Microcircuit devices using encryption algorithms are sometimes subject to attacks aimed at determining the secret data used, such as the key or keys used and perhaps, in certain cases, the information on the messages themselves.

Among the known attacks, attacks of the Simple Power Analysis (SPA) or Differential Power Analysis (DPA) types include measurement of the incoming and outgoing currents and voltages in the microcircuit during the execution of the encryption algorithm with the aim of deducing the secret or private key therefrom. The feasibility of this family of attacks was shown in particular in the article by P. Kocher, J. Jaffe and B. Jun entitled “Differential Power Analysis” published in Advances in Cryptology—Crypto 99 Proceedings, Lecture Notes In Computer Science Vol. 1666, M. Wiener, ed., Springer-Verlag, 1999. Specifically, on execution of the symmetric encryption algorithm known under the name Data Encryption Standard (DES), the sixteen iterations performed by that algorithm are clearly identifiable from power consumption measurements and it is possible statistically to extract therefrom the bits of the secret key used.

Also known are attacks by injection of fault(s), called Differential Fault Analysis (DFA) attacks, which include deliberate generation of faults during the execution of the encryption algorithm, for example, by disrupting the microcircuit on which the algorithm is being executed. Such disruption may include briefly lighting the microcircuit, or the generation of one or more voltage peaks on one of contacts of the microcircuit. This provides a way, subject to certain conditions, of exploiting the calculation and behavior errors generated so as to obtain a part or even the whole of the secret data sought.

In order to combat these attacks, which are varied in nature, many solutions which differ greatly between each other have been introduced. Embodiments of the invention relate more specifically to those solutions which implement a method including a step of generating at least one secret data protection parameter P and one step of modifying the execution of the encryption algorithm with that protection parameter P.

The latter is generally generated randomly, using a conventional random pseudo-data generator 20, such that the execution of the encryption algorithm 10 is itself rendered random and de-correlated from the secret data used, for example, by a technique commonly referred to as masking, also known as a data transformation or deformation method, since its manipulation is deformed as opposed to its raw use, performed, by a countermeasure section 22 of the microprocessor 18, using the protection parameter P. Thus, the encryption algorithm intermediary data and, subsequently, the measurable currents, are modified by the random protection parameter and observation thereof does not allow the secret data to be found. Conversely, masking does not modify the algorithm itself, which thus provides the same result with or without masking.

One method of this type is, for example, described in U.S. Pat. No. 6,278,783. One embodiment in the field of symmetric cryptography described in reference to FIGS. 1 and 2 of that document provides for the generation of unpredictable information items to mask the secret data having a key K and a message M. The procedure is as follows from step 100:

two unpredictable information items K1 and M1 are initially generated, from which other unpredictable information items K2 and M2 are derived such that

K2=K XOR K1 and M2=M XOR M1,

random permutations K1P, K2P, M1P, M2P are associated with the unpredictable information items such that K1P {K1} XOR K2P {K2} equals K and M1P {M1} XOR M2P {M2} equals M,

inverses of the permutations are applied to the unpredictable information items K1, K2, M1 and M2 and the encryption algorithm (in this case an adapted DES algorithm) is applied to the four permutated unpredictable information items rather than to the two secret data items.

At the end of the algorithm, in step 170, both parts of the ciphered message obtained are combined to form the same single encrypted message which could have been obtained by direct application of the encryption algorithm DES to the data K and M.

Another method of the same type, more specifically dedicated to DFA attacks, described in French Patent Publication No. FR 2 867 635, recommends executing an encryption algorithm a first time, with modification of the execution using a first randomly-generated parameter, and then executing that same encryption algorithm a second time, or executing the inverse or a portion thereof, with modification by a second randomly-generated parameter which is different from the first one, to check the proper execution of the algorithm on the first execution by comparing the results.

On each new execution of an encryption algorithm protected by a method of the above-mentioned type, different, and by definition unpredictable, information items are generated such that two successive executions of that algorithm are not comparable (only the final results). This can cause problems during the design on implementation error detection (debugging), because the algorithm cannot be executed twice under the same conditions. This may also cause problems on execution, in particular for detecting attacks by fault injection, because the solution which is recommended by FR 2 867 635 is fairly demanding in terms of calculation capacity required.

Another solution could include storage of the random variables generated so as to be able to reuse the variables if required, but this presents obvious security problems.

It is desirable to remedy the above-described disadvantages by providing a microcircuit protection method which is simple to implement and which offers a secure alternative to the conventional methods.

### BRIEF SUMMARY OF THE INVENTION

Embodiments of the invention relate to a method of protecting a microcircuit against attacks aimed at discovering secret data used on the execution, by the microcircuit, of an encryption algorithm including generating at least one protection parameter for the secret data and modifying the execution of the encryption algorithm using the protection parameter. The method further includes: providing at least one secret parameter stored in a secure memory of the microcircuit; defining at least one generating function allowing for the generation of a sequence of value by successive applications of the generating function to the secret parameter, the sequences of values being determinable only from the generating function and the secret parameter; and generating the protection parameter in a reproducible way from at least one value of the sequence of values.

The protection parameter thus retains its capacity to modify the execution of the encryption algorithm to block any attack while being reproducible, that is, the protection parameter is able to be found again by the microcircuit designer or manufacturer without requiring storage thereof. Only the function and the associated secret parameter(s) have to be defined and retained by the designer or manufacturer.

According to one embodiment, the secret data is a message, a symmetric cryptography secret key, an asymmetric cryptography private key, or a combination of these elements.

According to one embodiment, the method includes an initialization by defining the secret parameter, and each execution of the encryption algorithm is modified by a plurality of protection parameters that are generated respectively from elements p_{N(i-1)+1} to p_{Ni} in the sequence of values (pₙ) on an i-th execution of the encryption algorithm following the initialization.

According to one embodiment, the sequence of values is generated using the recurrence relation pₙ₊₁=q.pₙ+r, applied to secret parameters q, r, and p₀.

According to one embodiment, the sequence of values is generated using the recurrence relation pₙ₊₁=(q.pₙ+r) mod m, applied to secret parameters q, r, m, and p₀.

According to one embodiment, m is a positive integer power of 2.

According to one embodiment, the sequence of values includes values in a cyclic group GC with m elements and with a value p as generator element for the group and the multiplication as the internal composition law, and the step of generating the sequence of values includes: choosing an initial element p₀ for the sequence as being the generator element p to which the group GC internal composition law is applied k times; and changing from an element pᵢ of rank i to an element pᵢ₊₁ of rank i+1 by applying k′ times the group GC internal composition law; m, p, k, and k′ being secret parameters.

According to one embodiment, the sequence of values includes values in a Frobenius group, in particular the group of reversible affine transformations on a finite field GF(q), where the order q is a prime number of k bits, q and k being secret parameters.

According to one embodiment, the sequence of values includes values output from a shift register with linear feedback of size m such that the sequence elements check a relation of the type pₜ₊ₘ=αₘ.pₜ+αₘ₋₁.pₜ₊₁+ . . . +α₁.pₜ₊ₘ₋₁, where the αᵢ take the value 0 or 1, the parameters αᵢ, size m and the m first elements of the sequence of values being secret parameters.

According to one embodiment, the sequence of values is obtained by the recurrence relation pₙ₊₁=F(pₙ), where F carries out a Cyclic Redundancy Check calculation based on a Cyclic Redundancy Check polynomial, the first element of the sequence of values and the polynomial chosen being secret parameters.

According to one embodiment, the method includes: generating a plurality of sequences of values from a plurality of generating functions and from a plurality of corresponding secret parameters; combining the plurality of sequences of values generated with a pre-defined relation to generate a new sequence of values; and generating the protection parameter in a reproducible way from at least one value of the new sequence of values.

According to one embodiment, the method includes: combining the sequence of values with the encryption algorithm public parameters to generate a new sequence of values; and generating the protection parameter in a reproducible way from at least one value of the new sequence of values.

Embodiments of the invention also relate to a microcircuit device protected against attacks aimed at discovering secret data used on the execution, by the microcircuit, of an encryption algorithm, including at least one secure memory for the storage of the secret data, a data generator for the generation of at least one protection parameter for the secret data and a microprocessor for the execution, which is modified using the protection parameter, of the encryption algorithm. The data generator includes: a generating section configured to generate the sequence of values by successive application of at least one predetermined secret parameter, the sequence of values being determinable only from the secret parameter and from the generating function; and a section for supplying the protection parameter in a reproducible way from at least one value of a sequence of values supplied by the generating section , and the secret parameter is a predetermined parameter stored in the secure memory of the microcircuit.

According to one embodiment, the secret data is a message, a symmetric cryptography secret key, an asymmetric cryptography private key, or a combination of these elements.

According to one embodiment, the device is configured to perform an initialization by defining the secret parameter, and modifying each execution of the encryption algorithm using a plurality of protection parameters that are generated respectively from the elements p_{N(i-1)+1} to p_{Ni} of the sequence of values (pₙ) in an i-th execution of the encryption algorithm following the initialization.

According to one embodiment, the generating section is configured to supply a sequence of values obtained by the recurrence relation pₙ₊₁=q.pₙ+r, applied to secret parameters q, r, and p₀.

According to one embodiment, the generating section is configured to supply a sequence of values obtained by the recurrence relation pₙ₊₁=(q.pₙ+r) mod m, applied to secret parameters q, r, m, and p₀.

According to one embodiment, m is a positive integer power of 2.

According to one embodiment, the generating section is configured to supply a sequence of values, with values in a cyclic group GC with m elements with a value p as generator element for the group and the multiplication as internal composition law, and to perform: choosing an initial element p₀ for the sequence as the generating element p to which the group GC internal composition law is applied k times; changing the element p, of rank i to an element pᵢ₊₁ of rank i+1 by applying k′ times the group GC internal composition law; wherein m, p, k and k′ are secret parameters.

According to one embodiment, the generating section is configured to supply a sequence of values with values in a Frobenius group, in particular the group of reversible affine transformations on a finite field GF(q), where the order q is a prime number of k bits, q and k being secret parameters.

According to one embodiment, the generating section is configured to supply a sequence of values with values output from a shift register with linear feedback of size m such that the elements in the sequence comply with a relation such as pₜ₊ₘ=αₘ.pₜ+αₘ₋₁.pₜ₊₁+ . . . +α₁.pₜ₊ₘ₋₁, where the αᵢ take the value 0 or 1, the parameters αᵢ, the size m and the m first elements in the sequence of values being secret parameters.

According to one embodiment, the generating section is configured to supply a sequence of values obtained through the recurrence relation pₙ₊₁=F(pₙ), where F makes a Cyclic Redundancy Check calculation based on a Cyclic Redundancy Check polynomial, the first element of the sequence of values and the polynomial chosen being secret parameters.

According to one embodiment, the data generator is configured to: generate a plurality of sequences of values from a plurality of generating functions and from a plurality of corresponding secret parameters; combine the plurality of sequences of values generated using a pre-defined relation to generate a new sequence of values; and generate the protection parameter in a reproducible way from at least one value of the new sequence of values.

According to one embodiment, the data generator is configured to: combine the sequence of values generated with the encryption algorithm public parameters to generate a new sequence of values; and generate the protection parameter in a reproducible way from at least one value of the new sequence of values.

Embodiments of the invention also relate to a portable system, in particular a smart card, including a microcircuit device such as described above.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 represents diagrammatically the structure of a microcircuit device protected against attacks, of the conventional type,

FIG. 2 represents diagrammatically the structure of a microcircuit device protected against attacks, according to one embodiment of the invention,

FIG. 3 represents diagrammatically a smart card including the microcircuit device in FIG. 2, and

FIG. 4 illustrates the successive steps of one embodiment of a method for protecting a microcircuit according to the invention.

### DETAILED DESCRIPTION OF THE INVENTION

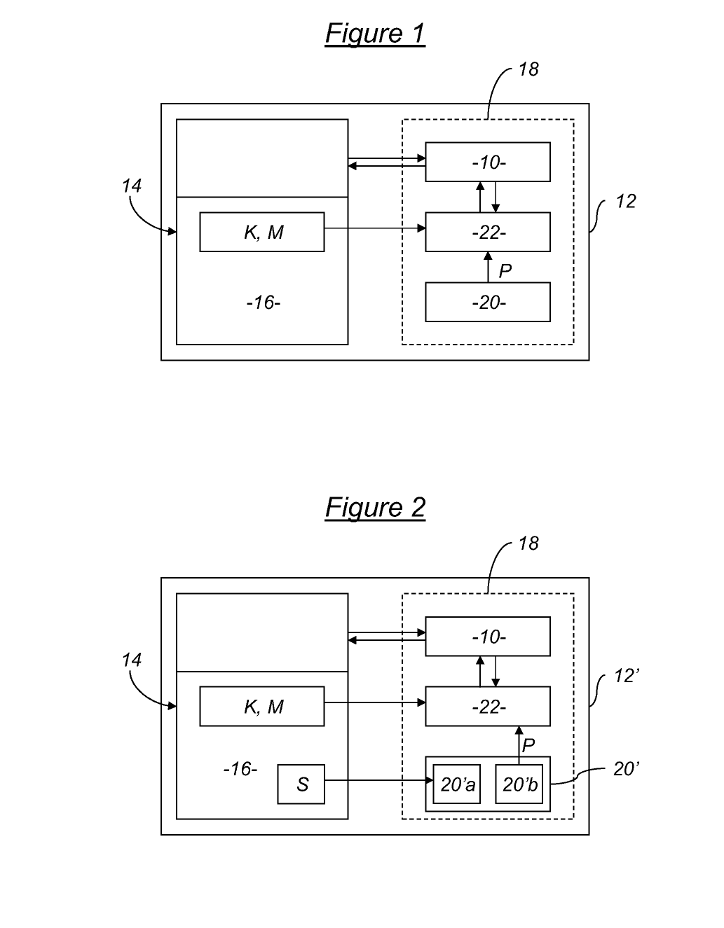

The microcircuit device 12′ represented in FIG. 2 has, like the circuit of FIG. 1, an encryption algorithm application 10, a memory 14 including a secure memory space 16, a microprocessor 18 and a countermeasure section 22. The secure memory space 16 is not accessible from the exterior of the microcircuit without authorization and/or authentication.

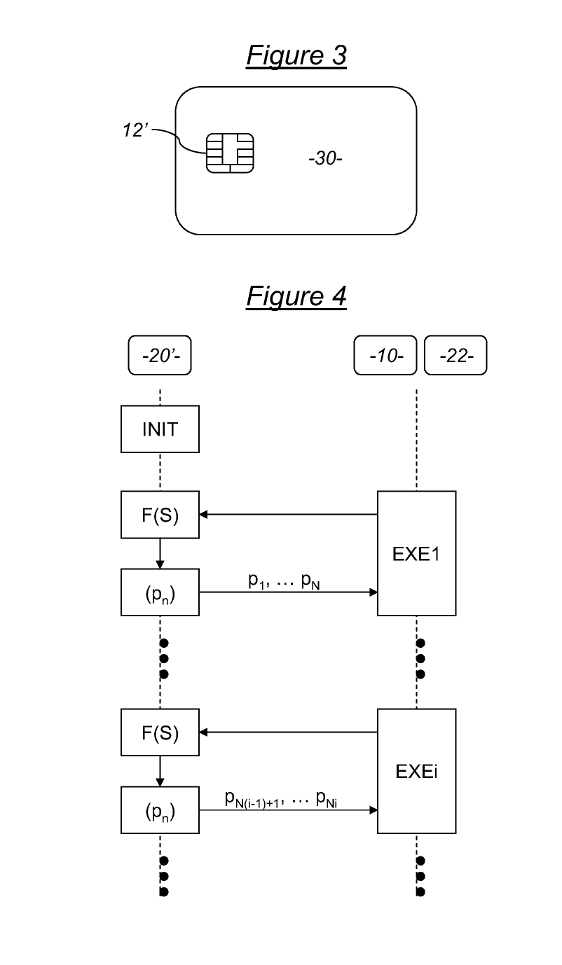

The microcircuit 12′ is, for example, integrated as a secure smart card chip 30 as represented in FIG. 3. However, although the encryption algorithm application 10 and the countermeasure section 22 were shown as being separate, these may in fact be closely imbricated (interwoven) in a single implementation of an encryption algorithm including a countermeasure.

Contrary to the system 12, in this system 12′ the conventional-type pseudo-random data generator 20 is replaced by a data generator 20′ which includes:

a section 20′a for applying a function F to at least one secret parameter S for the generation of a sequence of values which can only be determined from that secret parameter and that function F, and

a section 20′b for supplying at least one protection parameter P in a reproducible way from a value in that sequence.

Section 20′a is, in fact, a software or hardware implementation of the function F.

The secret parameter S is stored in the secure memory 16 and fed to section 20′a of the generator 20′, while the protection parameter P is output from the section 20′b to the countermeasure section 22.

The parameter P is thus not a random information item in the conventional sense. Rather, it is a deterministic result resulting from the calculation of the function F performed by the generator 20′ on at least one secret parameter S which may be specific to the smart card 30 on which the microcircuit 12′ is arranged. That secret parameter is, for example, derived from the series number of the card 30.

Repeatedly applying the function F to S generates a sequence (pₙ) for which the elements are the origin of the protection parameter(s) supplied by the generator. Generally speaking, the generator may supply as many parameters P resulting from the sequence values (pₙ) as are required, according to applying the countermeasure implemented in the card 30. That sequence (pₙ) can only be reproduced with the knowledge of the generating function F and the initial deterministic elements used (i.e., the parameter S).

Each protection parameter P may result directly from an element pₙ in the sequence (pₙ), in other words, P=pₙ. Alternatively, the element pₙ may be subjected to processing before supplying the parameter P. For example, P may be the result of a calculation P=pₙ XOR kₙ, where kₙ is a masking secret constant.

Needless to say, if the sequence (pₙ) is cyclic and/or works on a finished set of elements, the space for the values pₙ generated may be sufficiently large to withstand attacks. Indeed, the greater the space considered, the better the robustness of the countermeasure.

In the first instance, we are going to present several non-limiting examples of a sequence of values (pₙ) which may be supplied by a generator according to embodiments of the invention. Secondly, we will set out several possible uses of such sequence of values for the supply of protection parameters to various countermeasure applications.

Examples of Functions Generating Sequence of Values for the Supply of Protection Parameters

1) Functions Based on Arithmetic-Geometric Sequences

If the sequence of values (pₙ) is defined using the integer function F with integer values by the following relation:

pₙ₊₁=F(pₙ)=q.pₙ+r,

where q and r are secret parameters constituting, with the initial element p₀ for the sequence, the secret parameters S referred to above, protection parameters resulting from an arithmetic-geometric sequence can be supplied. The protection parameters are, for example, the elements in the sequence (pₙ).

If r=0, the relation is a geometric sequence for which a term pᵢ can be found, used in a precise step in the cryptography, using secret parameters q and p₀ as follows: pᵢ=qⁱ.p₀.

If q=1, the relation is an arithmetic sequence for which a term pᵢ can be found using secret parameters r and p₀ as follows: pᵢ=r.i+p₀.

If r is not nil and q is different from 1, the relation is an arithmetic-geometric sequence for which a term pᵢ can be found using secret parameters q, r and p₀ as follows: pᵢ=qⁱ.p₀+r.(qⁱ−1)/(q−1).

The space for the elements of the sequence (pₙ) can also be reduced by an integer number m using the following relation:

pₙ₊₁=F(pₙ) modulo m=(q.pₙ+r) modulo m.

It is noted that, if m is a prime number, that sequence takes the form of the group of reversible affine transformations on the finished field GF(m)={0, 1, . . . , m−1}.

m can also be chosen as a power of 2, to generate sequences of elements with a constant number of bits. For example, if one wants to generate sequences of parameters pᵢ with k bits, m=2^{k} is chosen.

Optionally, m forms part of the secret parameters to be retained in secure memory.

2) Functions Defining a Cyclic Multiplicative Group

Let GC be a cyclic group with m elements with a value p as element generator and the multiplication as internal composition law: GC={p, p², . . . p^{m}}. The sequence of values (pₙ) can be defined as follows:

the initial element p₀ is chosen as being the generator element p to which the group GC internal composition law is applied k times,

element pᵢ is changed to element pᵢ₊₁ by applying k′ times the group GC internal composition law.

The secret parameters S used for the function generating the sequence (pₙ) are then, for example, the generator element p and the values k, k′ and m. In addition, as above, the protection parameters P generated are, for example, the elements of the sequence (pₙ).

3) Functions Defining a Frobenius Group

Let GF(q) be a finished field, where the order q is a prime number of k bits. The group of reversible affine transformations on that finished field is a Frobenius group. An interesting property of Frobenius groups is that no nontrivial element fixes more than one point.

In this context, the useable affine transformations take the form of functions y=f(x)=a.x+b, where a≢0 and where the operations are made in the field GF(q). It is thus possible to define a function generating the sequence (pₙ) which applies to secret parameters q, a, b and p₀. By choosing for example q=2¹⁶+1 and, in hexadecimal notation, a=0×4cd3, b=0×76bb, p₀=0×ef34, a sequence is obtained starting with the terms p₁=0×c6cf, p₂=0×8baf, p₃=0×620d, p₄=0×0605, p₅=0×e70c, p₆=0×3049, p₇=0×e069, p₈=0×55ee, and so forth.

4) Functions Output from a Shift Register with a Linear Feedback (LFSR-Type Register)

For this type of function, it is a matter of choosing a secret parameter p₀, for example of 16 bits, and an LFSR shift register, for example with a corresponding output of 16 bits. If the size of the LFSR register is m, then a term pₜ₊ₘ of the sequence (pₙ) is determined by the m terms which precede it using a linear equation of the type:

pₜ₊ₘ=αₘ.pₜ+αₘ₋₁.pₜ₊₁+ . . . +α₁.pₜ₊ₘ₋₁, where αᵢ takes the value of 0 or 1.

5) Functions Defining a Cyclic Redundancy Check (CRC) Calculation

For this type of functions, it is a matter of choosing a secret parameter p₀, for example of 16 bits, and a corresponding CRC polynomial from those used conventionally in the CRC calculations, for example the polynomial CRC-16 (X¹⁶+X¹⁵+X²+1) or the polynomial CRC CCITT V41 (X¹⁶+X¹²+X⁵+1). A term pₙ₊₁ in the sequence (pₙ) is determined according to the preceding term pₙ by the relation pₙ₊₁=F(pₙ), where F carries out a CRC calculation based on the chosen polynomial.

6) Combinations of Sequence of Values

Indeed it is also possible to calculate several sequences of values, each for example according to one of the methods set out above, and to combine them using a function to generate a new sequence of values to be used as protection parameters. The sequence (pₙ) is thus generated, according to two other sequences (p′ₙ) and (p″ₙ), calculating for each index n, pₙ=T(p′ₙ, p″ₙ).

The function T in question may be a secret values matrix, the values p′ₙ and p″ₙ thus describing respectively a row and a column of that matrix.

7) Combinations Implying a Sequence of Values and Public Data

The sequence (pₙ) may be generated from a first sequence (p′ₙ), also according to public, not secret data, such as for example data used during the execution of the countermeasure cryptography application. Among that data, according to the applications, the message M (plain or encrypted), a public key Kpub (for an asymmetric cryptography application), or the like can be cited. The values of the sequence used as protection parameters are then calculated using any function COMB combining all these data:

pₙ=COMB(p′ₙ, M, Kpub, . . . ).

An advantage of this combination is that the sequence of values (pₙ) can be used not only to feed protection parameters to the encryption algorithm countermeasure application, but also to detect attacks by fault injection (in particular on the public data). Indeed, by regeneration of the sequence (p′ₙ) using the secret parameter(s), at the end of the execution of the encryption algorithm for example, then by using that regenerated sequence (p′ₙ) and public data such as appears at the end of execution, a check can be made whether or not the application of the COMB function produces the same sequence of values (pₙ) and thus whether or not the public data has been affected during the course of execution.

Examples of Using a Sequence of Values Generated According to One of the Methods above by an Encryption Algorithm with Countermeasure

### 1) FIRST EXAMPLE

As stated in the introduction, unpredictable information items are generated by the algorithm described in U.S. Pat. No. 6,278,783, during the course of step 100 to mask the secret data K (the secret key) and M (the message to be encrypted). The random, non-predictable generation of the parameters K1, M1, K1P and M1P as protection parameters, from which are then derived the parameters K2, M2, K2P and M2P, is an essential step in the method described which provides the way for thwarting attacks by analyzing energy consumption.

It would however be of advantage to replace step 100 by a step of generating non-random protection parameters through a generator 20′ according to one embodiment of the invention and not through a conventional generator 20 of pseudo-random data.

Since K1, M1, K1P and M1P are not necessarily represented on a same number of bits (for example, in the DES application envisaged in U.S. Pat. No. 6,278,783, K1 is represented in 56 bits whereas M1 is represented in 64 bits), each of those parameters can result from a sequence which is specific thereto. Thus, four families of secret parameters and four corresponding functions respectively are defined and stored, generating four sequences of values (K1ₙ), (M1ₙ), (K1Pₙ) and (M1Pₙ) from which are generated the four protection parameters K1ᵢ, M1ᵢ, K1Pᵢ and M1Pᵢ for an i-th execution of the DES application. In this case, a counter may memorize the index i, indicating the number of times that a system implementing that improvement of the DES algorithm has indeed executed the application since production of the system, or the last initialization thereof. As already stated, the protection parameters K1ᵢ, M1ᵢ, K1Pᵢ and M1Pᵢ may be generated not only from the sequences (K1ₙ), (M1ₙ), (K1Pₙ) and (M1Pₙ) but also according to the additional public data used during the course of execution.

At the end of cryptography, i.e., at step 170 of U.S. Pat. No. 6,278,783, each of the protection parameters used can then be generated a second time, in order to unmask the execution of the DES application between steps 110 and 160 so as to detect attacks by fault injection. Indeed, this regeneration step will lead to incorrect inverse permutations if a fault occurred and the results obtained cannot be used by the conventional fault analysis techniques.

During the course of the check on an implementation of the above-mentioned DES application, an i-th execution of that application can also be reproduced so as to be able to carry out effective debugging, thanks to the possibility of finding again simply the parameters K1ᵢ, M1ᵢ, K1Pᵢ and M1Pᵢ in the sequence of deterministic numbers.

### 2) SECOND EXAMPLE

As also stated in the introduction, unpredictable information items A1 and A2 are generated by the secure processing algorithm described in FR 2 867 635, for example during the course of steps E204 and E208. These unpredictable information items are generated randomly, independently of each other, so that they have every chance of being different in the most general case. The items are used, for example, independently on two consecutive executions of the same encryption algorithm, or of two encryption algorithms linked by their results.

Here again, A1 and A2 could advantageously be generated in a non-random way by a generator 20′ according to embodiments of the invention. In one embodiment of the invention, A1 and A2 result from a same sequence (pₙ) obtained for example, but not necessarily, according to one of the above-mentioned methods. Thus, on the i-th execution of the secure processing method envisaged in FR 2 867 635, instead of generating A1 and A2 in a random and independent way, A1 and A2 may be obtained as follows:

A1=p₂ᵢ₋₁,

A2=p₂ᵢ.

It is then easy to find again the values of A1 and A2 used on the i-th execution of the process method without the need to retain them in memory, either during the course of the process to check the integrity of the data handled, or subsequently to debug the process method where appropriate.

Similarly, creating a dependence relation between the numbers A1 and A2 may be created which could be useful in the countermeasures aimed at protecting from and detecting attacks by fault injection.

### 3) OTHER EXAMPLES

There are many known countermeasure systems and methods and again many more to be devised and produced. Generally speaking, each time an algorithmic countermeasure is used to modify the execution of a symmetric or asymmetric encryption algorithm, the generation of unpredictable information items introduced by the countermeasure is recommended. According to embodiments of the invention, it is advantageous to replace the unpredictable information with the non-random generation of protection parameters resulting from one or more sequences of values obtained through at least one secret parameter, as has been illustrated by the above two examples.

FIG. 4 illustrates an example of steps carried out by a method according to one embodiment of the invention, applied to the execution of any cryptography algorithm with countermeasure, using N protection parameters P₁, . . . P_{N} by execution, all the protection parameters being able to be extracted from a single sequence of values (pₙ) generated by the section 20′a.

On a first step INIT carried out by the generator 20′, a counter i is initialized at 0. This counter i is designed to retain in memory the number of times that the encryption algorithm was executed since that initialization step INIT, as long as another initialization is not performed.

During the course of that step, the secret parameter S (or the parameters S where there is more than one), from which the sequence of values has to be generated, is defined. It may be retained from a previous initialization, but may also be generated based on a new value at the time of that initialization. The secret parameter S is, for example, generated from unique identification data, as the series number of the smart card carrying the microcircuit 12′. The secret parameter S may also be generated from parameters or physical phenomena linked to the microcircuit at a given time, which may be random. In all cases, the secret parameter S is retained in memory in a secure way, to enable the microcircuit to regenerate a single sequence of values (pₙ) at any time, through the function implemented by the section 20′a.

The initialization step INIT may be unique in the microcircuit's life cycle, produced on design by the manufacturer or reproduced several times, for example regularly or each time that the counter i reaches a value imax.

On a first execution EXE1 of the encryption algorithm with countermeasure, the generator 20′, more specifically the section 20′a, is called once or more to apply the secret parameter S to the function F, so as to generate, in one or more times, a number N of elements of the sequence of values (pₙ): p₁, . . . From these N first elements, the N protection parameters P₁, . . . P_{N} are generated.

For example, for any k such as 1≦k≦N, Pₖ=pₖ.

As a variant, if one has N additional secret values Sec₁, Sec_{N} among the secret parameters S retained in secure memory, the following additional calculation can be carried out: for any k such as 1≦k≦N, Pₖ=Secₖ XOR pₖ, or Pₖ=Secₖ ADD pₖ, or indeed also Pₖ=Secₖ SUB pₖ, so as to transform (or deform or mask) the parameters used.

Subsequently, on an i-th execution EXEi of the encryption algorithm with countermeasure, the generator 20′, more specifically the section 20′a, is again called once or more times to apply the secret parameter S to the pre-defined function, so as to generate, in one or more times, a number N of additional elements of the sequence of values (pₙ): p_{N(i-1)+1}, . . . p_{Ni}. From these N additional elements, the N protection parameters P₁, . . . P_{N} are generated, as previously.

For example, for any k such as 1≦k≦N, Pₖ=p_{N(i-1)+k}.

As a variant, if one has N additional secret values Sec₁, . . . Sec_{N}, the following additional calculation can be carried out: for any k such as 1≦k≦N, Pₖ=Secₖ XOR p_{N(i-1)+k}, or Pₖ=Secₖ ADD p_{N(i-1)+k}, or also again Pₖ=Secₖ SUB p_{N(i-1)+k}, so as to transform (or deform, or mask) the parameters used.

Whatever the method used to generate the sequence(s) of values originating the protection parameters, knowledge of the method and secret values used by the method, including the initial parameter p₀ loaded beforehand into ROM memory or on a step in the microcircuit device life cycle in EEPROM memory, provides the way for finding again, at any time, the protection parameters generated and used in the system's life. It clearly appears that this particularity provides for simple, effective debugging and also improved resistance to attacks by fault injection.

The choice of the method used to generate the sequence of values and the protection parameter(s) is dictated by the application envisaged.

Moreover, the number of secret parameters may provide for defining the level of independence between the entity responsible for the development of the microcircuit device and its issuer.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of protecting a microcircuit against attacks aimed at discovering secret data used on execution, by the microcircuit, of an encryption algorithm, the method comprising:
generating at least one protection parameter P for the secret data; and
modifying the execution of the encryption algorithm using the at least one protection parameter P, the generation of the at least one protection parameter P including:
providing at least one secret parameter stored in a secure memory of the microcircuit;
defining at least one generating function allowing for the generation of a sequence of values pₙ, by successive applications of the generating function to the secret parameter, the sequence of values being determinable only from the generating function and the secret parameter;
generating at least one sequence of values pₙ, using the generating function and the secret parameter, and
generating the at least one protection parameter P in a reproducible way from at least one value of the sequence of values pₙ.

2. The method according to claim 1, wherein the secret data is a message, a symmetric cryptography secret key, an asymmetric cryptography private key, or a combination thereof.

3. The method according to claim 1, further comprising performing an initialization, which includes defining of the secret parameter, and in which each execution of the encryption algorithm is modified by a plurality of protection parameters P₁, . . . P_{N}, that are generated respectively from elements p_{N(i-1)+1} to p_{Ni} in the sequence of values pₙ on an i-th execution of the encryption algorithm following the initialization.

4. The method according to claim 1, wherein the sequence of values pₙ is generated using a recurrence relation pₙ₊₁=q.pₙ+r, applied to secret parameters q, r, and p₀.

5. The method according to claim 1, wherein the sequence of values pₙ, is generated using a recurrence relation pₙ₊₁=(q.pₙ+r) mod m, applied to secret parameters q, r, m, and p₀.

6. The method according to claim 5, wherein the secret parameter m is an integer power of 2.

7. The method according to claim 1, wherein the sequence of values pₙ includes values in a cyclic group GC with m elements, with a value p as element generator for the group and multiplication as internal composition law, and generation of the sequence of values pₙ includes:
choosing an initial element p₀ of the sequence as being the generator element p to which the group GC internal composition law is applied k times, and
changing from an element pᵢ of rank i to an element pᵢ₊₁ of rank i+1 by applying k′ times the group GC internal composition law, m, p, k and k′ being secret parameters.

8. The method according to claim 1, wherein the sequence of values pₙ includes values in a Frobenius group, the Frobenius group including reversible affine transformations on a finished field GF(q), wherein an order q is a prime number of k bits, q and k being secret parameters.

9. The method according to claim 1, wherein the sequence of values pₙ includes values output from a shift register with linear feedback of size m such that the elements in the sequence comply with a relation of the type pₜ₊ₘ=αₘ.pₜ+αₘ₋₁.pₜ₊₁+. . . +α₁.pₜ₊ₘ₋₁, where αᵢ takes the value 0 or 1, the parameters αᵢ, the size m, and the m first elements in the sequence of values pₙ being secret parameters.

10. The method according to claim 1, wherein the sequence of values pₙ is obtained by a recurrence relation pₙ₊₁=F(pₙ), where function F carries out a Cyclic Redundancy Check calculation based on a Cyclic Redundancy Check polynomial, the first element in the sequence of values pₙ and the chosen polynomial being secret parameters.

11. The method according to claim 1, further comprising:
generating a plurality of sequences of values p′ₙ, p″ₙ from a plurality of generating functions and from a plurality of corresponding secret parameters,
combining the plurality of sequences of values p′ₙ, p″ₙ through an ore-defined relation to generate a new sequence of values pₙ, and
generating the protection parameter P in a reproducible way from at least one value of the new sequence of values pₙ.

12. The method according to claim 1, further comprising:
combining a sequence of values p′n with public parameters of the encryption algorithm to generate a new sequence of values pₙ, and
generating the protection parameter P in a reproducible way from at least one value of the new sequence of values pₙ.

13. A microcircuit device protected against attacks aimed at discovering secret data used on execution, by the microcircuit, of an encryption algorithm, the microcircuit device comprising:
a secure memory configured to store the secret data;
a data generator configured to generate at least one protection parameter P for the secret data; and
a microprocessor configured to execute the encryption algorithm, modified using the protection parameter P, the data generator including:
a generating section configured to generate the sequence of values pₙ by successive application of at least one predefined generating function to at least one predetermined secret parameter, the sequence of values pₙ being determinable only from the secret parameter and the generating function, and
a section configured to supply the protection parameter P in a reproducible way from at least one value of the sequence of values pₙ supplied by the generating section, the secret parameter being a predetermined parameter stored in the secure memory of the microcircuit.

14. The microcircuit device according to claim 13, wherein the secret data is a message, a symmetric cryptography secret key, an asymmetric cryptography private key, or a combination thereof.

15. The microcircuit device according to claim 13, wherein:
the generating section is configured to perform an initialization that includes defining of the secret parameter, and
the microprocessor is configured to modify each execution of the encryption algorithm using a plurality of protection parameters P₁, P_{N} that are generated respectively from elements p_{N(i-1)+1} to p_{Ni} of the sequence of values pₙ on an i-th execution of the encryption algorithm following the initialization.

16. The microcircuit device according to claim 13, wherein the generating section is configured to supply the sequence of values pₙ, which are obtained through a recurrence relation pₙ₊₁=q.pₙ+r, applied to secret parameters q, r, and p₀.

17. The microcircuit device according to claim 13, wherein the generating section is configured to supply the sequence of values pₙ, which are obtained through a recurrence relation pₙ₊₁=(q.pₙ+r) mod m, applied to secret parameters q, r, m, and p₀.

18. The microcircuit device according to claim 17, wherein m is an integer power of 2.

19. The microcircuit device according to claim 13, wherein the generating section is configured to supply the sequence of values pₙ, which includes values in a cyclic group GC with m elements, with a value p as generator element for the group and multiplication as internal composition law, and is further configured to:
choose an initial element p₀ of the sequence as being the generator element p to which the group GC internal composition law is applied k times, and
change the element pᵢ of rank i to an element pᵢ₊₁ of rank i+1 by applying k′ times the group GC internal composition law, m, p, k and k′ being secret parameters (S).

20. The microcircuit device according to claim 13, wherein the generating section is configured to supply the sequence of values pₙ, which includes values in a Frobenius group, the Frobenius group including reversible affine transformations on a finished field GF(q), where an order q is a prime number of k bits, q and k being secret parameters.

21. The microcircuit device according to claim 13, wherein the generating section is configured to supply the sequence of values pₙ, which includes values output from a shift register with a linear feedback of size m such that the sequence elements comply with a relation of the type pₜ₊ₘ=αₘ.pₜ+αₘ₋₁.pₜ₊₁+ . . . +α₁.pₜ₊ₘ₋₁, where the αᵢ takes the value 0 or 1, the parameters αᵢ, the size m, and the m first elements of the sequence of values pₙ being secret parameters.

22. The microcircuit device according to claim 13, in which the generating section is configured to supply the sequence of values pₙ, which are obtained through a recurrence relation pₙ₊₁=F(pₙ), where a function F performs a Cyclic Redundancy Check calculation based on a Cyclic Redundancy Check polynomial, the first element of the sequence of values and the chosen polynomial being secret parameters.

23. The microcircuit device according to claim 13, wherein the data generator is configured to:
generate a plurality of sequences of values p′ₙ, p″ₙ from a plurality of generating functions and from a plurality of corresponding secret parameters,
combine the plurality of sequences of values p′ₙ, p″ₙ using a predefined relation to generate a new sequence of values pₙ, and
generate the protection parameter P in a reproducible way from at least one value of the new sequence of values pₙ.

24. The microcircuit device according to claim 13, wherein the data generator is configured to:
combine a sequence of values p′ₙ with public parameters of the encryption algorithm to generate a new sequence of values pₙ, and
generate the protection parameter P in a reproducible way from at least one value of the new sequence of values pₙ.

25. A portable device comprising a microcircuit device according to claim 13.
